(19) United States
(12) Patent Application Publication
(10) Pub. No.: US 2016/0117632 A1
(43) Pub. Date: Apr. 28, 2016

(54) INFORMATION PROCESSING APPARATUS, COMMODITY SALES SYSTEM, AND COMMODITY SALES METHOD

(71) Applicant: TOSHIBA TEC KABUSHIKI KAISHA, Tokyo (JP)

(72) Inventor: Shinsaku Ito, Yokohama (JP)

(21) Appl. No.: 14/521,520

(22) Filed: Oct. 23, 2014

(51) Int. Cl. G06Q 10/08; G06K 9/62

(52) U.S. Cl. CPC G06Q 10/087; G06K 9/6202; G06K 9/6215

(57) ABSTRACT

An information processing apparatus according to an embodiment includes an interface and a control unit. The interface receives image data including an object image transmitted from a first terminal. The control unit extracts a feature value of the object image in the image data, compares the feature value and feature values of commodities registered beforehand, calculates similarity for each of the commodities, and transmits information concerning the commodity having similarity equal to or larger than a specified value to the first terminal using an interface.

### FIELD

Embodiments described herein relate generally to a technique employing an image recognition technique.

### BACKGROUND

In general, as a method for commodity purchase, there are the following two systems:

1. A customer visits a store, directly selects a commodity, purchases the commodity, and carries the commodity back home.

2. A customer selects a commodity displayed on a personal computer or the like in an Internet site and requests the commodity to be delivered to a home.

However, in the former case 1, there is a drawback (a problem) in that it takes labor and time to search for a desired commodity in a sales floor. In the latter case 2, there is a drawback (a problem) in that the customer has to wait for some time until the customer receives a commodity after purchasing the commodity or delivery date and time is limited to date and time when the customer stays at home.

### DESCRIPTION OF THE DRAWINGS

FIG. 1 is a diagram for explaining an overview of an embodiment;

FIG. 2 is a diagram showing an overall configuration example of a system in the embodiment;

FIG. 3 is a block diagram showing a configuration example of a portable terminal;

FIG. 4 is a block diagram showing a configuration example of a server;

FIG. 5 is a block diagram showing a configuration example of a personal computer;

FIG. 6 is a block diagram showing a configuration example of a store apparatus;

FIG. 7A is a diagram showing an example of a data table stored in a storage unit of the server beforehand;

FIG. 7B is a diagram showing an example of a data table stored in a storage unit of the store apparatus beforehand;

FIG. 8 is a flowchart for explaining an operation example of the portable terminal;

FIG. 9 is a flowchart for explaining an operation example of the server;

FIG. 10 is a flowchart for explaining an operation example of image recognition processing and candidate list creation processing of the server; and

FIG. 11 is a diagram showing an operation example of the store apparatus.

### DETAILED DESCRIPTION

An information processing apparatus according to an embodiment includes an interface and a control unit. The interface receives image data including an object image transmitted from a first terminal. The control unit extracts a feature value of the object image in the image data, compares the feature value and feature values of commodities registered beforehand, calculates similarity for each of the commodities, and transmits information concerning the commodity having similarity equal to or larger than a specified value to the first terminal using an interface.

A commodity sales system according to the embodiment specifies commodities on the basis of information such as photograph images, texts, or sound and conveniently generates a shopping list of commodities selected by a user. In the commodity sales system according to the embodiment, a store prepares commodities on the basis of the generated shopping list. The user can visit the store and receive the commodities at time designated in the shopping list. Reception date and time designated in the shopping list can be used for management of commodities and price determination.

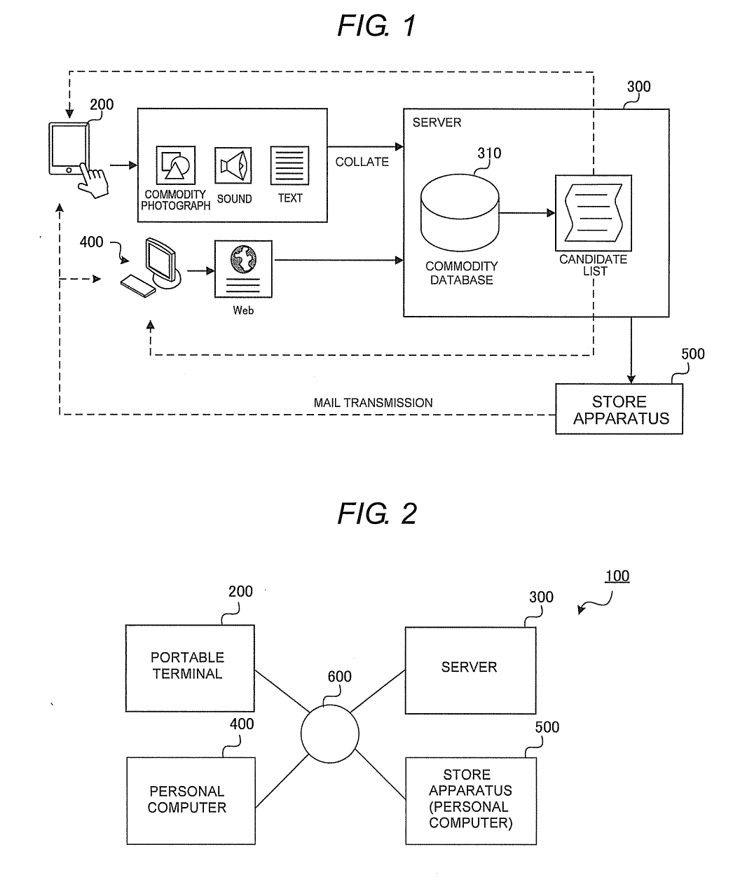

The embodiment is explained below. FIG. 1 is a diagram for explaining a system overview in the embodiment. FIG. 2 is a diagram showing an apparatus configuration example of the commodity sales system. A commodity sales system 100 in the embodiment includes a portable terminal 200, a server 300, a personal computer 400, and a store apparatus 500. The server 300 updates, every time a commodity is purchased, a database 310 for managing commodities sold by a store. The portable terminal 200 refers to the commodity database 310 via a network 600 using a dedicated application introduced beforehand. The personal computer 400 accesses the commodity database 310 using a browser application introduced beforehand.

The portable terminal 200 and the personal computer 400 are computers owned by a user who desires to purchase commodities. The server 300 is a server (an information processing apparatus) for managing commodities and the like sold in stores in a group. The store apparatus 500 is a computer set in each of the stores. The store apparatus 500 stores commodities sold in the store, unit prices of the commodities, quantities of stock, and the like. The apparatuses can transmit and receive data to and from one another via the network 600 including a wide area line network. One or a plurality of portable terminals 200 and one or a plurality of personal computers 400 are present according to the number of uses. When a plurality of stores are present in the group, a plurality of store apparatuses 500 are present according to the number of stores. When only one store is present, one store apparatus 500 may be present. The server 300 and the store apparatus 500 may be integrated. The server 300 may have a redundant configuration according to performance.

The portable terminal 200 (or the personal computer 400) transmits image data, on which commodities desired to be purchased are projected, to the server 300 via a predetermined operation screen. The server 300 analyzes the image using an image recognition technique and specifies a commodity having high similarity to images of the image data out of commodities registered in the commodity database 310. When there are a plurality of commodities having high similarities to the images of the image data, the server 300 creates a candidate list of the commodities and returns the candidate list to the portable terminal 200, which is a transmission source of the image data.

The portable terminal 200 registers a commodity selected by the user out of the candidate list in a shopping list. The portable terminal 200 includes information concerning a store where the user receives the commodity and reception date and time in the shopping list and transmits the shopping list to the server 300. The server 300 transmits the shopping list to the store apparatus 500 set in the store where the commodity is handed over to the user. The store apparatus 500 transmits a confirmation mail of the reception date and time to the portable terminal 200. When the commodity is sold at a price lower than a price in the store, the store apparatus 500 changes the price in the store to the lower price and transmits the mail.

In the commodity sales system 100, collation by text data or sound data is also possible. In the case of the text data, the server 300 creates the candidate list on the basis of matching (or partial matching) or mismatching of a character string of a commodity name. In the case of the sound data, the portable terminal 200 converts the sound data into text data and transmits the text data. The server 300 creates the candidate list on the basis of matching or mismatching of a character string in the same manner.

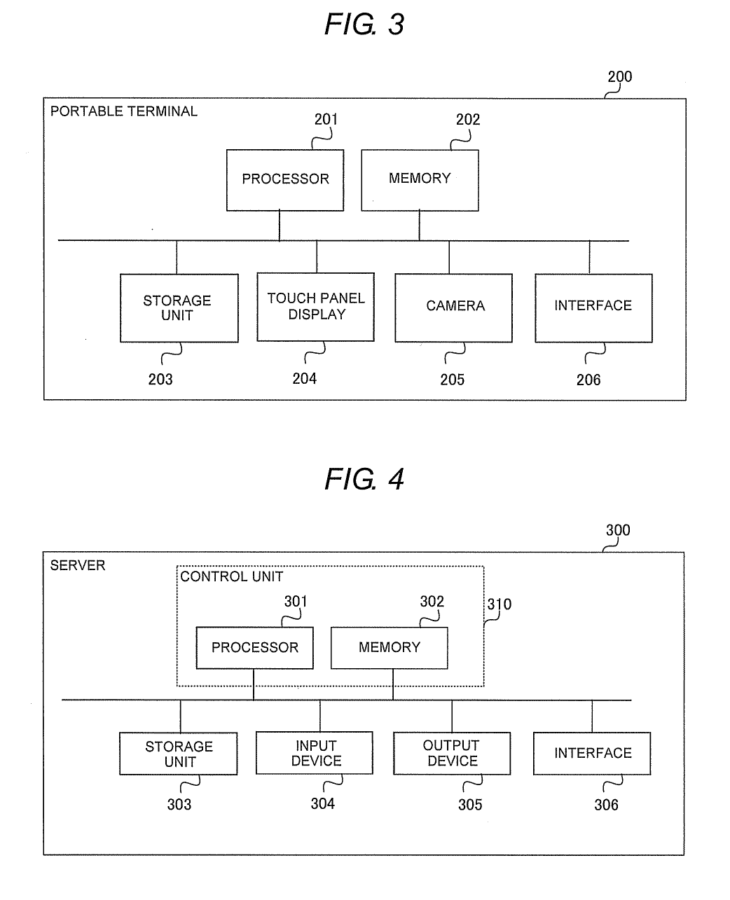

FIG. 3 is a block diagram showing a configuration example of the inside of the portable terminal 200. In this embodiment, it is assumed that the portable terminal 200 is a smart phone or a tablet PC (Personal Computer) having a camera function. The portable terminal 200 includes a processor 201, a memory 202, a storage unit 203, a touch panel display 204, a camera 205, and an interface 206. The processor 201 is an arithmetic unit such as a CPU (Central Processing unit). The processor 201 controls respective kinds of hardware in the portable terminal 200. The memory 202 includes, for example, a RAM (Random Access Memory) configured to store data in a volatile manner and a ROM (Read Only Memory) configured to store data in a nonvolatile manner. The storage unit 203 is an auxiliary storage device such as a flash memory. The touch panel display 204 includes a display unit of a liquid crystal panel and an input unit of a touch sensor stacked on the surface of the display unit.

The camera 205 includes an optical system such as a lens and an image pickup device such as a CCD (Charge coupled device) image sensor. The camera 205 photoelectrically converts an image of light obtained via the lens into electronic data. The converted image (electronic data) is stored in, for example, the storage unit 203. The interface 206 includes a communication device conforming to a short range wireless communication standard and a communication device connectable to a wide area line network and a wireless LAN. In this embodiment, the interface 206 performs communication with the server 300 and the store apparatus 500 via the wide area line network.

FIG. 4 is a block diagram showing a configuration example of the inside of the server 300, which is the information processing apparatus. The server 300 includes a processor 301, which is an arithmetic unit such as a CPU, and a memory 302 including a volatile storage device and a nonvolatile storage device. The server 300 includes a storage unit 303, which is an auxiliary storage device such as a HDD. The server 300 includes an input device 304 such as a keyboard and a mouse, an output device 305 such as a monitor, and an interface 306 such as a network card. A control unit 310, which is a controller, includes the processor 301 and the memory 302. The control unit 310 may further include the storage unit 303.

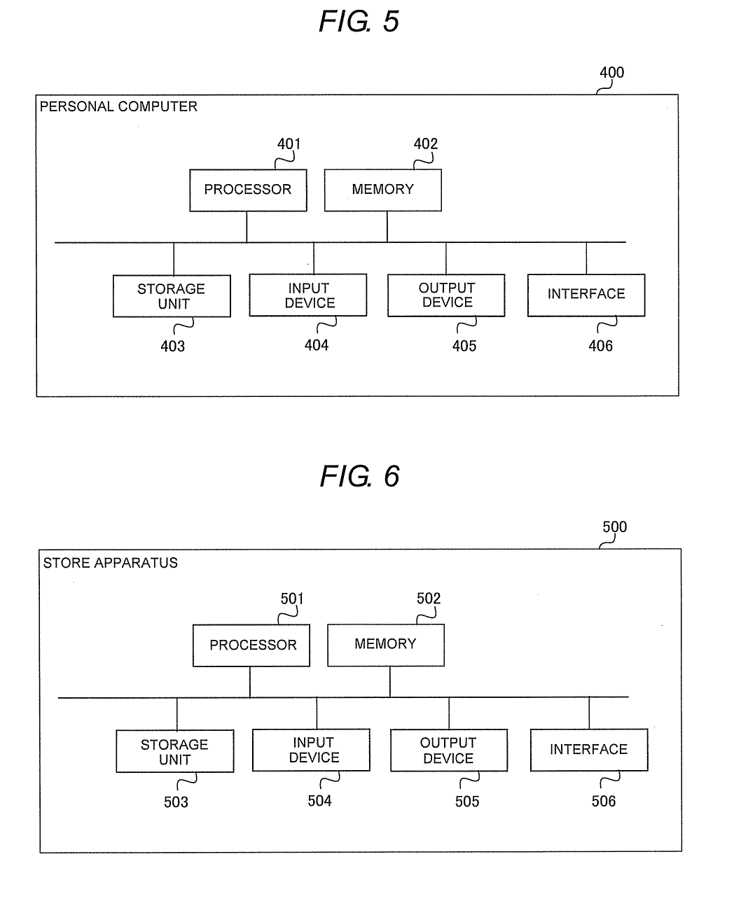

An internal configuration of the personal computer 400 is shown in FIG. 5. An internal configuration of the store apparatus 500 is shown in FIG. 6. Both of the personal computer 400 and the store apparatus 500 are computers and have the same configuration as the server 300. Therefore, detailed explanation of the personal computer 400 and the store apparatus 500 is omitted.

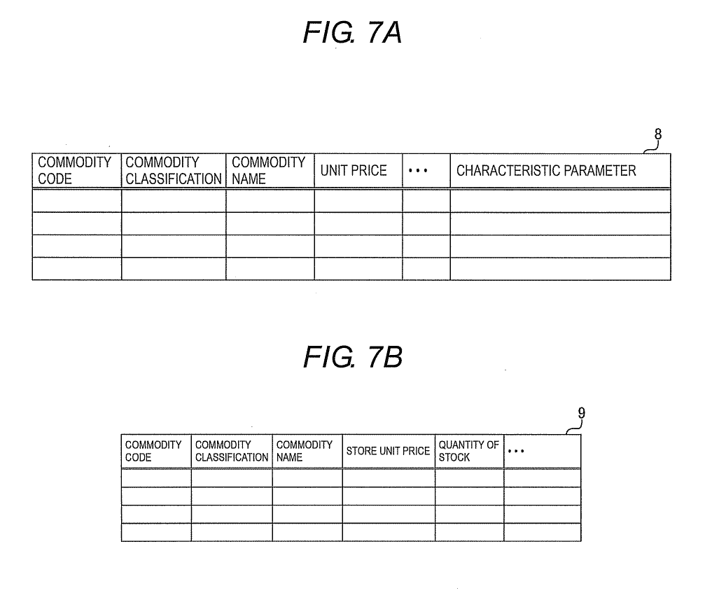

The storage unit 303 of the server 300 includes the commodity database 310 for managing commodities sold in stores in a group. One table of the commodity database 310 is shown in FIG. 7A. In a table 8, in association with commodity codes for identifying commodities, types and attributes (commodity classifications), names (commodity names), unit prices, and feature parameters of the commodities are stored. The types of the commodities may be classifications such as food, clothes, and miscellaneous goods or may be further subdivided classifications. The feature parameters are numerical value representations of feature values of standard appearances of the commodities such as shapes, surface tints, patterns, and uneven states of the commodities. The storage unit 303 may store raw image data of the commodities instead of the feature parameters.

FIG. 7B is an example of a table stored in the storage unit 503 of the store apparatus 500. In a table 9, unit prices in the store and quantities of stock in the store are stored in addition to the commodity codes, the types and the attributes (commodity classifications), and the names (commodity names).

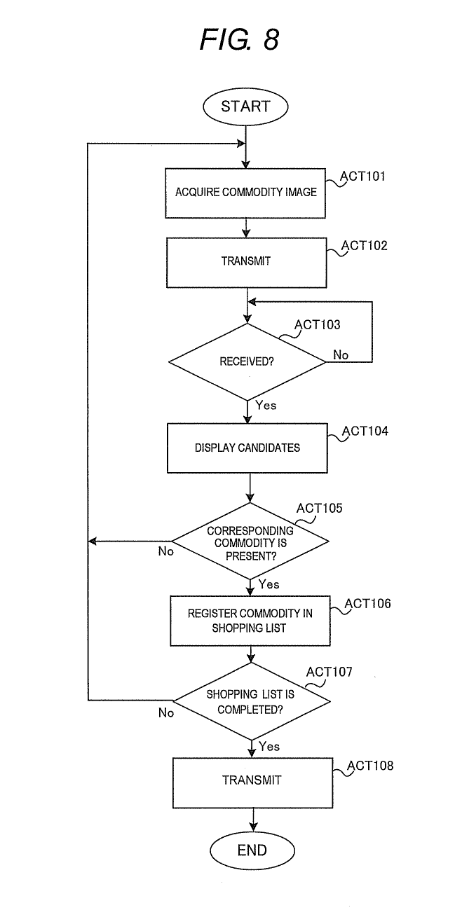

FIG. 8 is a flowchart for explaining an operation example of the portable terminal 200. The personal computer 400 can perform the same operation. The processor 201 loads a computer program stored in the storage unit 203 beforehand to the memory 202 and executes an arithmetic operation of the computer program to execute the flowchart while controlling the units.

The processor 201 of the portable terminal 200 acquires a commodity image using an application installed in the storage unit 203 beforehand (ACT 101). In the embodiment, the commodity image is a photograph image obtained by taking a close-up picture of a desired commodity or a commodity similar to the desired commodity using the camera 205. However, the commodity image may be image data of a catalog, a magazine, a television video, or the like in which the desired commodity is published. That is, the commodity image only has to be image data including an image of the desired commodity (object). The processor 201 causes the interface 206 to operate and transmits the image to the server 300 (ACT 102). At this point, the processor 201 may transmit information concerning a type of the commodity (a value of a commodity classification in FIG. 7A) together with the image. The processor 201 displays an inquiry screen on the touch panel display 204 at arbitrary timing in order to obtain the information.

The processor 201 stays on standby until a candidate list is received (ACT 103, a loop of No). When the candidate list is received (ACT 103, Yes), the processor 201 displays the received candidate list on the touch panel display 204 (ACT 104).

The processor 201 determines whether the user selects a desired commodity from the candidate list (Act 105). When the desired commodity of the user is absent in the candidate list (ACT 105, No), the processor 201 determines that the commodity image is a mismatch and performs processing for image acquisition again (returns to ACT 101). On the other hand, when the desired commodity of the user is selected from the candidate list (ACT 105, Yes), the processor 201 registers the selected commodity (specifically, a commodity code of the commodity) in a shopping list (ACT 106). The number of purchased items and the like of the commodity are also input. The processing in ACTS 101 to 106 is performed until the shopping list is completed (ACT 107, No.). When the shopping list is completed (ACT 107, Yes), the processor 201 transmits the shopping list to the server 300 via the interface 206 (ACT 108). The shopping list includes information concerning a decided store where the user receives the commodity, information concerning date and time of reception, and the number of orders of each of purchased items of the commodity. The information concerning a store where the user receives the commodity is information for enabling unique determination of the store such as identification information of the store or a store name of the store. When the shopping list is transmitted, a mail address of the user is also added. The mail address is used as a transmission destination of a confirmation mail explained below. In order to obtain these kinds of information, the processor 201 displays an inquiry screen on the touch panel display 204 at arbitrary timing in the respective acts.

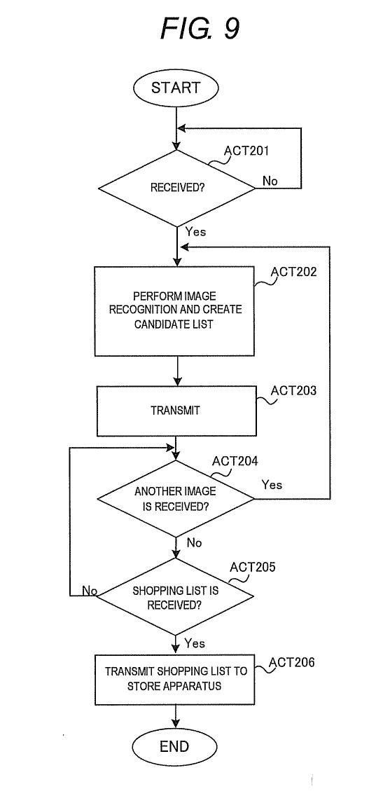

FIG. 9 is a flowchart for explaining an operation example of the server 300. The processor 301 loads a computer program stored in the storage unit 303 beforehand to the memory 302 and executes an arithmetic operation of the computer program to execute the flowchart while controlling the units.

The processor 301 of the server 300 stays on standby until data including a commodity image is received from the portable terminal 200 (or the personal computer 400) via the interface 306 (ACT 201, a loop of No). When the data is received (ACT 201, Yes), the processor 301 performs recognition processing for the received image and creates a candidate list (ACT 202). Details of ACT 202 is explained below.

The processor 301 transmits the created candidate list to the portable terminal 200, which is a transmission source of the data, using the interface 306 (ACT 203). The processor 301 stays on standby until another image is received or a shopping list is received (ACT 204, No and ACT 205, a loop of No). When another image is received because, for example, the previous image is a mismatch (ACT 204, Yes), the processing returns to ACT 202 and a candidate list is created again.

When the shopping list is received (ACT 205, Yes), the processor 301 transmits the shopping list to the store apparatus 500 of the store (ACT 207). After the transmission, the processor 301 may receive a presence or absence check result of stock from the store apparatus 500 and, when there is no stock, notify the portable terminal 200 to that effect.

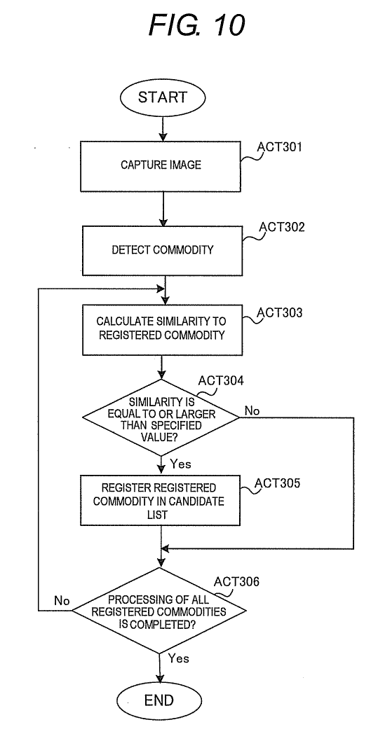

An example of the image recognition and the operation for creating a candidate list in ACT 202 is explained with reference to FIG. 10. The processor 301 stores a captured image in the memory 302 (ACT 301). The processor 301 detects all or a part of commodities from the captured image (ACT 302). The processor 301 detects all or a part of the images included in the captured image using a pattern matching technique or the like. Specifically, the processor 301 extracts a contour line or the like from an image obtained by binarizing the captured image.

The processor 301 reads a feature value of the commodity from the image and compares the feature value with the feature parameter (the feature value) of the commodity registered in the table 8 shown in FIG. 7A to calculate similarity with the registered commodity (ACT 303). The processor 301 reads, from all or a part of picked up images of a commodity, states of the surface such as a tint of the commodity and an unevenness state of the surface as feature values. The processor 301 does not have to take into account the contour and the size of the commodity to reduce processing time. The processor 301 compares the read feature values and the feature parameters registered in the table 8 and calculates similarity. The similarity indicates to which degree all or a part of the picked up images of the commodity are similar to the commodity images of the commodity registered in the table 8 when the similarity of the commodity image of the commodity registered in the table 8 is assumed to be 100%=“similarity: 1.0”. For example, the similarity may be calculated by changing weight for the tint and the unevenness state of the surface. In this example, the feature values of the registered commodities are extracted as the parameters beforehand. However, the image data of the registered commodities may be stored in association with the records of the table 8. In this case, the processor 301 calculates a feature value of the registered image every time the image is registered and compares the feature value with a feature value of a picked-up image.

Recognizing an object included in an image in this way is called generic object recognition. Concerning the generic object recognition, an existing technique may be adopted. There is also known a technique for performing the generic object recognition by segmenting an image for each object.

In this example, similarity between a picked-up commodity image and the registered commodities registered in the table 8 is calculated as an absolute evaluation. However, the similarity may be calculated as a relative evaluation. When the similarity is calculated as the absolute evaluation, the picked-up commodity image and the registered commodities registered in the table 8 are compared one to one. Similarity derived as a result of the comparison is directly adopted. When the similarity is calculated as the relative evaluation, if it is assumed that five registered commodities are registered in the table 8, the similarity of the picked-up commodity image is calculated such that the similarity is, for example, 0.6, 0.1, 0.1, 0.1, 0.1, and the like for each of the registered commodities and a sum of similarities to the registered commodities is 1.0 (100%).

When a commodity type (a value of the commodity classification in FIG. 7A) is transmitted from the portable terminal 200, the processor 301 compares feature values after narrowing down search targets with the value. Consequently, it is possible to reduce the number of search targets and reduce processing time.

The processor 301 determines whether the similarity of the registered commodity currently being processed is equal to or larger than a specified value (e.g., 80%) (ACT 304). When the similarity is not equal to or larger than the specified value (ACT 304, No), the processing proceeds to ACT 306. When the similarity is equal to or larger than the specified value (ACT 304, Yes), the processor 301 adds the registered commodity in the candidate list (ACT 305). The candidate list in which the commodity is registered includes the commodity code, the commodity classification, the commodity name, and the unit price shown in FIG. 7A as one record. In this embodiment, when images are recognized by mistake, the candidate list is created in order to cause the user to finally select an image.

The processor 301 determines whether the feature value comparison is performed for all the registered commodities (when the commodity type is transmitted, all the registered commodities after being narrowed down) (ACT 306). When the feature value comparison is performed for not all the registered commodities (ACT 306, No), the processor 301 performs the similarity calculation for the remaining registered commodities (ACT 303). When the comparison processing is completed for all the registered commodities (ACT 306, Yes), the processor 301 proceeds to ACT 203 of the next processing (see FIG. 9). After ACT 306, the processor 301 may sort the candidate list such that the commodities are arranged in order from the commodity having the highest similarity. When the similarity is calculated as the relative evaluation, for example, a higher order specified number of (e.g., higher order two) commodities are registered in the candidate list.

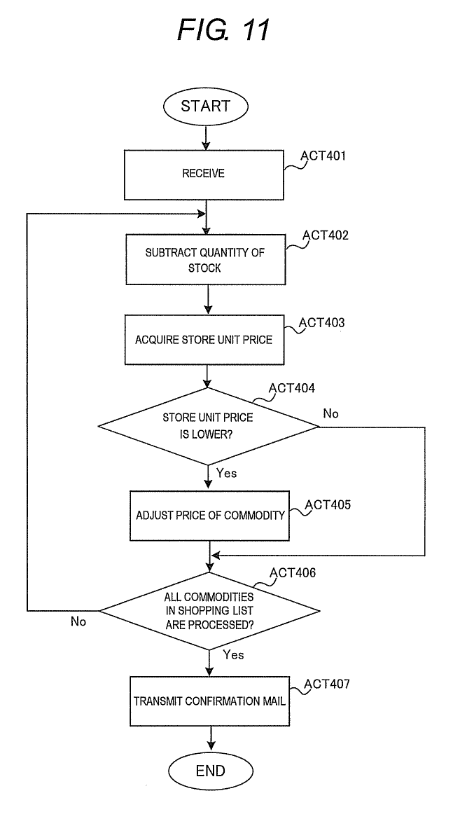

An operation example of the store apparatus 500 performed when a shopping list transmitted from the server 300 is received is explained with reference to FIG. 11. A processor 501 of the store apparatus 500 receives the shopping list from the server 300 (ACT 401). The processor 501 searches through the table 9 (see FIG. 7B) with a commodity code registered in the shopping list and subtracts the number of orders from the quantity of stock of a commodity corresponding to the commodity code (ACT 402). When there is no quantity of stock, the processor 501 may notify the server 300 to that effect.

The processor 501 acquires a store unit price of the commodity from the table 9 (ACT 403) and determines whether the store unit price is lower than a setting unit price (the unit price in the table 8 stored in the server 300) (ACT 404). When the store unit price is lower (ACT 404, Yes), the processor 501 changes the unit price of the commodity to the store unit price (ACT 405). For example, when a bargain sale limited to the store is performed, the store unit price sometimes fluctuates according to a date, a period of time, or the like. ACT 405 is performed to adjust the unit price of the commodity to the store unit price.

ACTS 402 to 405 are carried out for all commodities in the shopping list (ACT 406, a loop of No). When all the commodities in the shopping list are processed (ACT 406, Yes), the processor 501 transmits a confirmation mail to the portable terminal 200 via the interface 506 (ACT 407). The confirmation mail includes text data including information concerning a store where the user receives a commodity, information concerning date and time of receipt, a commodity name, the number of commodities, and a commodity unit price (when adjusted, a store unit price) as a list and includes a total amount. The processor 501 shapes and incorporates these data in a text of a mail and transmits the mail to a mail address of the user.

Concerning hand-over of the commodity, the store prepares the commodity on the basis of the shopping list by the designated date and time and notifies the user (a purchaser) as soon as possible when the preparation is completed. The purchaser directly visits the store and receives the purchased commodity. When the purchased commodity is food, the purchaser prepares the commodity taking into account a freshness date set in the commodity data.

The purchase procedure explained above is only an example. In this example, a commodity is specified using a picked-up image in the portable terminal 200 such as a smart phone or a tablet PC. However, a commodity name may be input by sound or text. Like a general EC (electronic commerce) site, a WEB site in which commodities are placed on the Internet may be provided to enable the user to create a shopping list from the personal computer 400 or photograph a coupon and get a discount.

In the explanation in this embodiment, the function for carrying out the invention is recorded in the apparatus in advance. However, the same function may be downloaded to the apparatus from a network. The same function recorded in a recording medium may be installed in the apparatus. A form of the recording medium may be any form as long as the recording medium is a recording medium that can store a computer program and can be read by the apparatus such as a CD-ROM. The functions obtained by the installation or the download in advance in this way may be realized in cooperation with an OS (operating system) in the apparatus.

According to this embodiment, it is possible to conveniently select a desired commodity and select a commodity, a name of which is unknown, as a purchase target.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An information processing apparatus comprising:
an interface configured to receive image data including an object image transmitted from a first terminal; and
a control unit configured to extract a feature value of the object image in the image data, compare the feature value and feature values of commodities registered beforehand, calculate similarity for each of the commodities, and transmit information concerning the commodity having similarity equal to or larger than a specified value to the first terminal using an interface.

2. The apparatus according to claim 1, wherein, when a plurality of the commodities having similarities equal to or larger than the specified value are present, the control unit further creates a list of the plurality of commodities and transmits the list to the first terminal.

3. The apparatus according to claim 2, wherein
the interface further receives information concerning a commodity selected from the list and information concerning a store transmitted from the first terminal, and
the control unit further transmits, using the interface, on the basis of the information concerning the store, the information concerning the store to a store apparatus that manages commodities of the store.

4. The apparatus according to claim 3, wherein
the interface further receives, from the first terminal, information concerning date and time when a user receives the commodity, and
the control unit further transmits the information concerning the date and time to the store apparatus using the interface.

5. The apparatus according to claim 1, wherein
the interface further receives information indicating a type of a commodity, and
the control unit further extracts commodities, commodity types of which are the information, out of the commodities registered beforehand, compares feature values of the extracted commodities and the feature value of the object image, and calculates similarities of the commodities.

6. The apparatus according to claim 1, wherein the interface receives image data obtained by picking up an image of the object.

7. A commodity sales system comprising:
a first terminal configured to transmit image data including an object image; and
a server configured to receive the image data, extract a feature value of the object image in the image data, compare the feature value and feature values of commodities registered beforehand, calculate similarity for each of the commodities, and transmit information concerning the commodity having similarity equal to or larger than a specified value to the first terminal.

8. The system according to claim 7, wherein, when a plurality of the commodities having similarities equal to or larger than the specified value are present, the server further creates a list of the plurality of commodities and transmits the list to the first terminal.

9. The system according to claim 8, further comprising one or a plurality of store apparatuses configured to manage commodities of a store, wherein
the server receives information concerning a commodity selected from the list and information concerning the store transmitted from the first terminal, and
the control unit further transmits, using the interface, the information concerning the store to the store apparatus on the basis of the information concerning the store.

10. A commodity sales method comprising:
a first terminal transmitting image data including an object image; and
a server receiving the image data, extracting a feature value of the object image in the image data, comparing the feature value and feature values of commodities registered beforehand, calculating similarity for each of the commodities, and transmitting information concerning the commodity having similarity equal to or larger than a specified value to the first terminal.
